(19) United States
(12) Patent Application Publication
(10) Pub. No.: US 2008/0226075 A1
(43) Pub. Date: Sep. 18, 2008

(54) Restricted services for wireless stations

(75) Inventor: Matthew Stuart Gast, San Francisco, CA (US)

Correspondence Address: PERKINS COIE LLP, P.O. BOX 1208, SEATTLE, WA, 98111-1208, US

(73) Assignee: Trapeze Networks, Inc., Pleasanton, CA (US)

(21) Appl. No.: 12/077,051

(22) Filed: Mar. 14, 2008

Related U.S. Application Data
(60) Provisional application No. 60/918,109, filed on Mar. 14, 2007.
(60) Provisional application No. 60/918,107, filed on Mar. 14, 2007.

(51) Int. Cl. H04L 9/28; H04L 9/32; G06F 21/00

(52) U.S. Cl. 380/270; 726/5; 380/44

(57) ABSTRACT

A technique for providing restricted access to a wireless network involves recognizing a service descriptive identifier (SDID). The SDID may be transmitted to wireless stations that query the wireless network so that the wireless stations can at least gain access to restricted services provided by the wireless network. The SDID may include quality of service (QoS) parameters, as well, thereby facilitating dynamically restricted access to the wireless network.

### CROSS REFERENCE TO RELATED APPLICATIONS

This application claims priority to provisional application No. 60/918,109 entitled “Emergency Call Services for Clients with Public Security Credentials”, filed Mar. 14, 2007, and provisional application No. 60/918,107, entitled “Use of TSPEC by SSPN Admission Control”, filed Mar. 14, 2007, both of which are incorporated by reference.

### BACKGROUND

A wireless network offers bandwidth over a local area. Wireless stations that are able to access services offered by the wireless network can take advantage of those services. It is frequently desirable to security-enable wireless networks. Unfortunately, this can make it impossible for wireless clients that are not pre-authorized to access the security-enabled network.

Wireless networks are frequently governed by 802.11 standards. While not all networks need to use all of the standards associated with 802.11, a discussion of the standards by name, such as 802.11e provides, at least partly because the standards are well-known and documented, a useful context in which to describe issues as they relate to wireless systems. For example, issues related to providing appropriate voice quality over wireless networks are known. The IEEE addressed this problem through quality of service (QoS) specifications in 802.11e. To accelerate availability of 802.11e, the Wi-Fi Alliance published a pre-standard “snapshot” called Wi-Fi Multimedia (WMM).

Traditionally, 802.11 telephones have been segregated onto separate networks to isolate the effects of a breach of their low security capabilities (e.g., manual WEP). Separate networks are advantages from a QoS setup perspective because QoS parameters can be applied to an entire network. As 802.11 telephones become more capable of high-security operation with WPA and 802.111, there may be less of a need to have a separate network. Current implementations of QoS specifications typically perform a mapping to a WMM access class by mapping an entire service set identifier (SSID), writing a cumbersome access control list (ACL), or automatically mapping DiffServ Code Point bits. ACLs are often written so that only one can be applied at a time, and DiffServ code points depend on the sender of the traffic to mark packets as requesting the appropriate service quality rather than some potentially higher class of service. Nothing within the 802.11e or WMM specifications addresses how to manage assigning the appropriate QoS to frames. Thus, QoS parameters are provisioned in a static manner.

These are but a subset of the problems and issues associated with security-enabled wireless networks and QoS provisioning for wireless networks, and are intended to characterize weaknesses in the prior art by way of example. The foregoing examples of the related art and limitations related therewith are intended to be illustrative and not exclusive. For example, wireless clients may use different protocols other than 802.11e, potentially including protocols that have not yet been developed. However, problems associated with QoS provisioning may persist. Other limitations of the relevant art will become apparent to those of skill in the art upon a reading of the specification and a study of the drawings.

### BRIEF DESCRIPTION OF THE DRAWINGS

FIG. 1 depicts an example of a system for providing restricted services over a wireless network.

FIG. 2 depicts an example of a station having an SDID.

FIG. 3 depicts an example of a restricted services wireless network system.

FIG. 4 depicts a flowchart of an example of a method for providing restricted services on a wireless network.

FIG. 5 depicts a flowchart of an example of a method for accessing restricted services on a wireless network.

FIG. 6 illustrates an example of a system including a wireless access domain.

### DETAILED DESCRIPTION

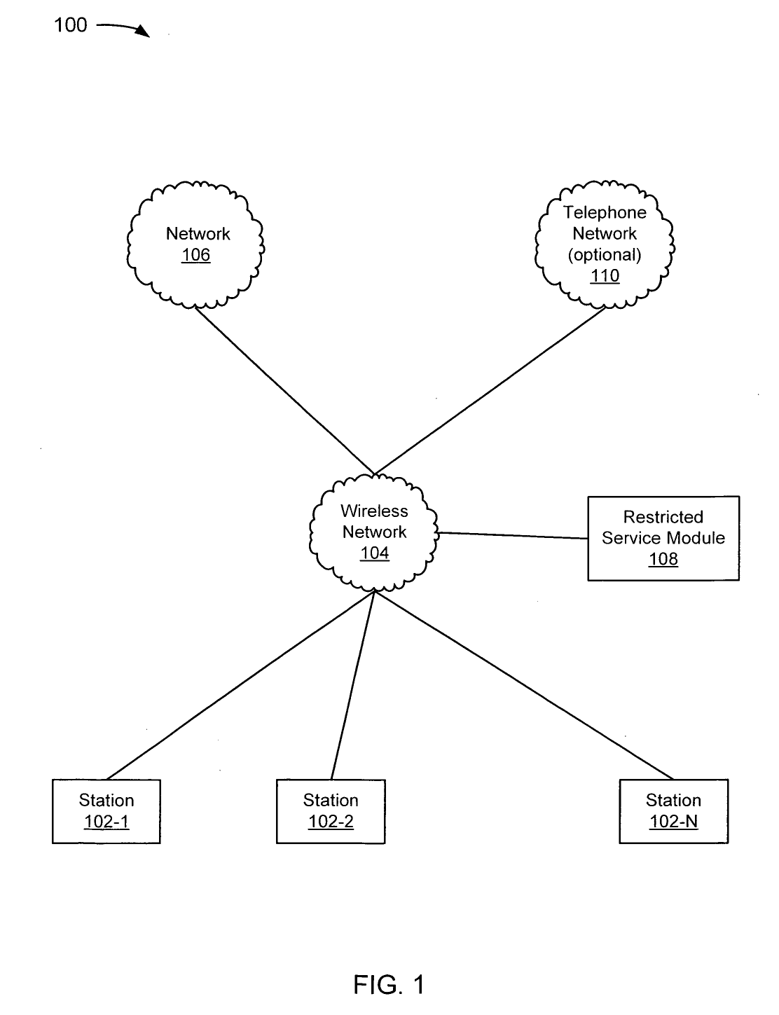

FIG. 1 depicts an example of a system 100 for providing restricted services over a wireless network. The system 100 can include stations 102-1 to 102-N (referred to collectively as stations 102), a wireless network 104, a network 106, a restricted services module 108, and a telephone network 110.

In the example of FIG. 1, the stations 102 can include any known or convenient wireless devices. By way of example but not limitation, the stations 102 can include relatively fixed devices (e.g., workstations, office equipment, etc.) and relatively mobile devices (e.g., laptops, personal digital assistants, IP phones, multi-mode phones, etc.). Depending upon the implementation or embodiment, the stations 102, or a subset thereof, can include a wireless Network Interface Card (NIC).

The term “station” is typically used in 802.11 networks, and may include any known or convenient devices that would be referred to as “stations” in such networks. By way of example but not limitation, the stations 102 may include an access point (AP). In ad hoc networks, some such stations may not be extant. It should be noted that the stations of ad hoc networks are not normally referred to as including APs.

In the example of FIG. 1, the wireless network 104 can include any known or convenient wireless network. By way of example but not limitation, the wireless network 104 can include a Wireless Local Area Network (WLAN) that provides wireless connectivity for a given premises or locality of arbitrary or particular size. By way of example but not limitation, the wireless network 104 can include an 802.11 network. In the example of FIG. 1, the stations 102 are coupled to the wireless network 104. It should be noted that stations are frequently part of the wireless networks to which they are coupled. Indeed, one or more of the stations 102 can be APs that are dispersed throughout the volume of the wireless network 104, providing wireless coverage within that volume. Nevertheless, the stations 102 are depicted as distinct from the wireless network 104 for illustrative purposes.

For illustrative purposes, the wireless network 104 may be thought of as servicing a particular premises, such as a corporate office building, a museum, a supermarket, a restaurant, a residence, a movie theater, a garage, a park, or any other area where a wireless network can be offered (i.e., practically anywhere). By way of example but not limitation, the owner or manager of a premises can provide the wireless network 104 to customers, visitors, or employees. Wireless networks often extend outside of a premises; legal, geographical, or other boundaries are not critical to an understanding of this paper, however.

In the example of FIG. 1, the network 106, which is coupled to the wireless network 104, can include any known or convenient network. By way of example but not limitation, the network 106 can include a Local Area Network (LAN), a Wide Area Network (WAN), or the Internet. The network 106 may include one or more wireless networks, which are not depicted distinctly because they are either not relevant (e.g., wireless networks controlled by an entity that is not related to the entity controlling the wireless network 104), or do not add to the illustrative value of the figure (e.g., wireless networks that are illustratively redundant with the description of the wireless network 104 in this paper).

The network 106 can include a corporate network providing services such as document management, resource management, email, digital file management, or any other type of services. Thus, at least a portion of the network 106 can be private and only accessible over the wireless network 104 to authenticated users, such as employees of a corporation in a corporate network. The network 106 may also include a wired backbone to which the wireless network 104 is coupled. At times, it may be convenient to refer to the wired backbone as part of the wireless network 104 for illustrative reasons.

In the example of FIG. 1, the restricted service module 108 is coupled to the wireless network 104. The physical location of the restricted service module 108 can be different depending upon implementation and embodiment. By way of example but not limitation, the restricted service module 108 may reside on a server (not shown) that resides on a wired backbone in the network 106, or on one of the stations 102. In some implementations or embodiments, the restricted service module 108 can be physically distributed. By way of example but not limitation, the restricted service module 108 could include modules on one or more of the stations 102 and on a server in the wireless network 104 or the network 106. The restricted service module 108 is typically implemented on a computer-readable medium, such as a known or convenient memory coupled to a processor.

The restricted service module 108 can include a database or other data store including user accounts and access rights associated with each user account. Such user accounts can include, by way of example but not limitation, user name, password, metadata (e.g., time of last access). The user accounts can also include guest accounts associated with restricted services.

In the example of FIG. 1, the telephone network 110 is coupled to the wireless network 104. It may be noted that the telephone network 110 could actually be coupled to the wireless network 104 through, by way of example but not limitation, a wired backbone in the network 106; the telephone network 110 is depicted in FIG. 1 as is for illustrative purposes. Depending upon the implementation and/or embodiment, the telephone network 110 can provide access to, by way of example but not limitation, Plain Old Telephone Service (POTS), a telephony network, or some other telephone network. Advantageously, the telephone network 110 may provide access to a land line, thereby allowing, e.g., users of IP phones to make telephone calls through the wireless network 104 and through the telephone network 110.

In the example of FIG. 1, in operation, stations 102 attempt to connect to the wireless network 104. There are a number of known or convenient ways to form such a connection. Typically, this involves a user of a station selecting a network, a station deciding upon a network using stored rules, or a station being assigned a network. In an illustrative embodiment, a Service Descriptive Identifier (SDID) is transmitted periodically or upon request/query from the wireless network 104 (e.g., from an AP) to a station. Since the station then knows the SDID, the station can send the SDID to the wireless network 104, which, assuming the wireless network 104 is security enabled, generates keys and encrypts communications. Advantageously, the station can then be granted access to a restricted service.

As a specific example, say a user has a multi-mode phone that includes cellular and 802.11 functionality. At certain locations, the multi-mode phone does not have cellular coverage. Let's say one such location where the user does not have cellular coverage is the underground garage of a premises that provides security-enabled 802.11 wireless coverage, and the user does not have any recognizable association with the premises or the wireless network. The user can nevertheless use a provided SDID to access restricted services, such as a telephone network. Specifically, the owner of the premises may grant emergency telephone access (e.g., in the U.S.A., the ability to dial 911) to anyone in the underground garage. Tying this specific example back to the more general example of FIG. 1, this means one or more of the stations 102 are associated with the wireless network 104 by way of provided SDIDs, and the restricted service module 108 grants the one or more of the stations 102 access to the telephone network 110 (specifically, emergency services), but not necessarily to the network 106.

As another specific example, say a user has an 802.11-enabled device and visits a museum that provides a security-enabled 802.11 wireless network, and the user is simply a guest of the museum. When the user walks through the museum, the museum can use the user's 802.11-enabled device (assuming it is operating) using known or convenient techniques to track the location of the user at a given time. When the user stands near a particular display, the user can be granted access to a particular sound-track that describes the display (or to a multimedia presentation, if the device is capable of receiving multimedia). Since location tracking is sometimes difficult, it may be desirable to provide multiple tracks if the 802.11-enabled device is a playback device capable of selecting from multiple tracks, from which the user can select. That way the user will not receive the wrong track when standing between two displays, or if location detection is off by some amount. Tying this specific example back to the more general example of FIG. 1, this means one or more of the stations 102 are associated with the wireless network 104 by way of provided SDIDs, and the restricted service module 108 grants the one or more stations access to the network 106 (specifically, a media server that provides audio or multimedia content to a user based upon the detected location of the station).

Other examples of restricted services include, by way of example but not limitation, executables or other content from a content server, limited telephone access (e.g., to specific phone numbers), services provided from an external network (e.g., the Internet), etc. It is practically impossible to list every service that could be provided using SDIDs. It may be noted that the SDID could be used to access restricted services, and then the user could be moved to a higher-access network in certain cases (e.g., by providing a password that was not proffered during authentication). It may be noted that there may be multiple layers of restricted services, and access is granted based upon environmental or other variables (e.g., a wireless network enters an ultra-secure mode at night, and you must use the SDID to enter, but you can upgrade to a higher access network if you provide additional authentication data). It may be noted that the wireless network 104 could provide multiple different SDIDs for different restricted services, if such a breakdown is deemed desirable.

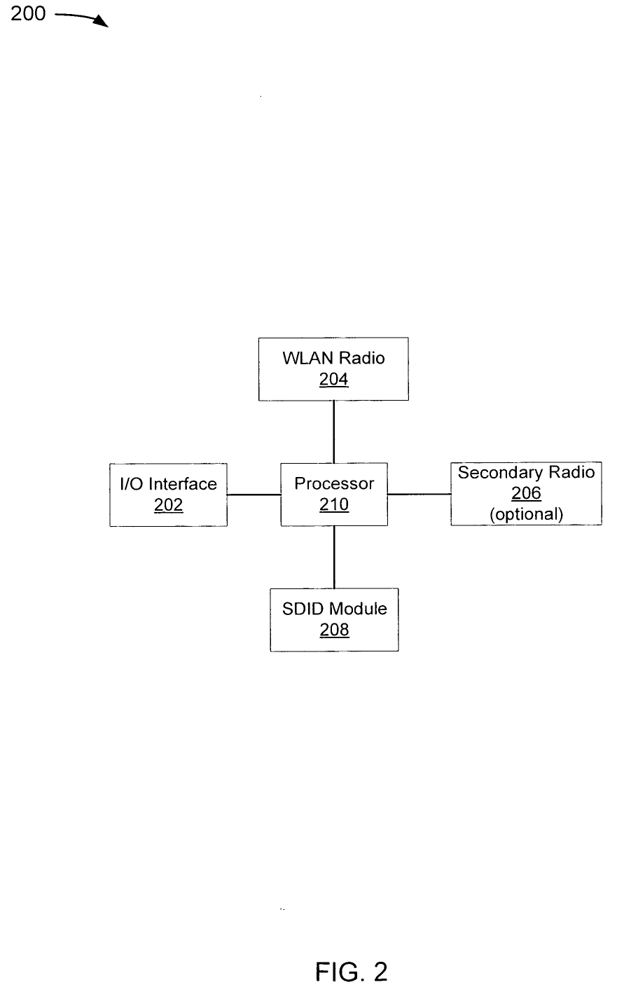

FIG. 2 depicts an example of a station 200 having an SDID. The station 200 includes an I/O interface 202, a WLAN radio 204, a secondary radio 206, an SDID module 208, and a processor 210 coupled by way of example to each of the depicted components.

In the example of FIG. 2, the I/O interface 202 can enable interaction with a human or computing device via applicable known or convenient techniques. Input devices can include a keyboard, a numerical touchpad, a touch screen, a microphone, or any other applicable known or convenient device configured to accept an input. An output device can include a display screen, a speaker, a headphone jack, indicator lights, or any other applicable known or convenient device configured to provide an output to a user.

In the example of FIG. 2, the WLAN radio 204 can enable wireless communication on a first wireless network. The WLAN radio 204 can be compliant with any applicable known or convenient protocol, such as 802.11 standards. In an alternative, multiple WLAN radios can be included. Each WLAN radio can be configured to communicate through a WLAN protocol. In this way, multiple WLAN protocols can be supported. For illustrative purposes, the WLAN radio 204 is intended to represent any number of WLAN radios.

In the example of FIG. 2, the secondary radio 206 can enable wireless communication on a second wireless network. By way of example but not limitation, the secondary radio 206 can be compliant with any applicable known or convenient protocol, such as a cellular network protocol.

In the example of FIG. 2, the SDID module 208 can be implemented in a computer-readable medium. For example, the SDID module 208 can be implemented in applicable known or convenient computer-readable memory. In a simple form, the SDID module 208 could simply include an SDID stored in a computer-readable data store. Alternatively, the SDID module 208 can include a transient key provided during a transient key exchange such as during a 4-way handshake. Generally, the SDID module 208 stores SDID data sufficient to enable the station 200 to access a wireless network service on a wireless network associated with the SDID.

The SDID module 208 can include memory to store computer-readable instructions as well as any run-time variables required for execution. The memory can include both volatile and non-volatile memory. For example, memory can include random-access memory (RAM), read-only memory (ROM), flash memory, hard drive, or other types of memory.

In the example of FIG. 2, the processor 210 can control the I/O interface 202, the WLAN radio 204, the secondary radio 206, and/or the SDID module 208. The processor 210 need not be a single processor, and could include multiple shared processors, or processors dedicated to particular components. Any known or convenient one or more processor devices and/or configurations can be used.

In the example of FIG. 2, the station 200 can be a fixed or mobile device configured to access a wireless network using the WLAN radio 204. For example, the wireless device 200 can include a laptop, a personal digital assistant, an IP phone, a desktop, or a workstation. The wireless device 200 can access services provided by the wireless network and provide a user interface for a user via the I/O interface 202. As is well-known, in many implementations the wireless device will include a network interface card (NIC). However, a system could be built that would not require the use of a NIC that would be technologically sound (though such a system may suffer from a lack of compatibility with standards-based systems).

In the example of FIG. 2, in operation, SDID data may be received on the WLAN radio 204. The SDID data may include a user name, a password, a network identifier, a cryptographic key, or some other data that is used to authenticate the station 200 for receipt of a service. The SDID data is stored in the SDID module 208. The WLAN radio 204 can then request access to services on a wireless network associated with the SDID.

In some cases, a user can choose from a variety of networks. Depending upon the implementation and/or embodiment, the user may view available networks via the I/O interface 202. In some cases, the type of network is advertised, enabling the user to select a network based upon, e.g., the services offered.

In some cases, the secondary radio 206 can be unusable. For example, if the secondary radio 206 is associated with a cellular network, and coverage does not extend to a current location, it may be that the only available network is the wireless network associated with the SDID. In such a case, it may be that the only network connection available to the station 202 is via the WLAN radio 204.

In some cases, the secondary radio 206 can include a personal area network (PAN) radio. A PAN radio may be compatible with, by way of example but not limitation, Bluetooth, Wibree, ZigBee, or some other protocol, and can be used for location detection or short-range communications. Because PAN radios have a limited transmission range, if the PAN radio is in communication with a second PAN radio, the wireless device must be within a short distance, for example, three feet, of the second PAN radio. In this way, exceptionally localized services may be provided via a WLAN to appropriately configured multi-mode devices having a WLAN radio and a PAN radio when the device is relatively close to a particular location of interest.

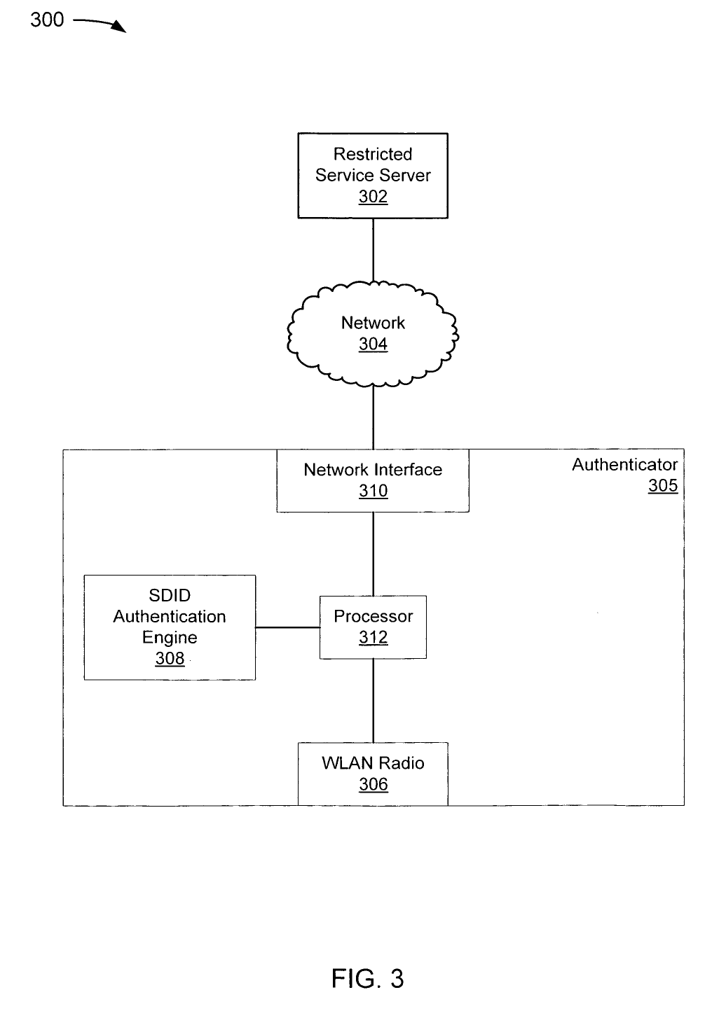

FIG. 3 depicts an example of a restricted services wireless network system 300. The system 300 includes a restricted service server 302, a network 304, and an authenticator 305.

In the example of FIG. 3, the restricted service server 302 is responsible for providing restricted services to wireless stations. As described herein, the restricted services are “restricted” because they are, at least in some embodiments, provided freely to wireless stations without knowledge of the user of the wireless stations. For example, the authentication data needed to access the restricted services can be broadcast to all stations within a particular range or near a particular location.

In the example of FIG. 3, the authenticator 305 includes a WLAN radio 306, an SDID authentication engine 308, a network interface 310, and a processor 312 coupled by way of example but not limitation to each of the depicted components.

In the example of FIG. 3, the WLAN radio 306 can include any known or convenient WLAN radio. The WLAN radio 306 can be implemented at an AP, or some other node at which wireless stations connect wirelessly to a wired backbone. The AP could also be implemented as an untethered AP, which is coupled to one or more other APs and eventually to a wired backbone.

The SDID authentication engine 308 can be implemented at an AP, or some other node at which wireless stations connect wirelessly to a wired backbone. The AP could also be implemented as an untethered AP. The SDID authentication engine 308 is responsible for broadcasting, or otherwise transmitting an SDID. The transmission of the SDID can be by any applicable known or convenient mechanism, such as by way of example but not limitation a beacon frame. The SDID authentication engine 308 is also responsible for determining whether a wireless station is authorized to access restricted services. Obviously, since the SDID authentication engine 308 transmits the SDID to wireless stations, it is expected that the wireless stations that receive the SDID will eventually be granted access to restricted services, if the wireless stations request them. Because of this expectation, it may be desirable to position the SDID authentication engine 308 relatively close in proximity to the WLAN radio 306 (e.g., on an AP). In this way, the transmission of the SDID and the authentication of the wireless station that sends the SDID can be accomplished with minimal traffic upstream. This becomes even more significant when untethered APs are used, since wireless resources are particularly valuable.

The network interface 310 couples the authenticator 305 to the network 304. Typically, the network 304 includes a wired backbone to which wireless stations, such as by way of example but not limitation APs are coupled. The authenticator 305 can be implemented as an AP. In such an implementation, authentication of wireless stations may be accomplished exclusively or primarily at the AP. The authentication process may also make use of an authentication server in a known or convenient manner.

If the authenticator 305 is implemented as an AP and a controller, the controller portion of the AP/controller authenticator may be pushed up into the network 304. The restricted service server 302 and the controller may even be implemented on the same device. Authentication responsibilities can be distributed between the AP and the controller. In general, an SDID module will be required at the AP so that the AP is able to recognize the SDID of a wireless station as an ID, even if all other authentication processes are implemented in the controller. The authentication process may also make use of an authentication server in a known or convenient manner.

The processor 312 can control the WLAN radio 306, the SDID authentication engine 308, and/or the network interface 310. The processor 312 need not be a single processor, and could include multiple shared processors, or processors dedicated to particular components. Any known or convenient one or more processor devices and/or configurations can be used.

In the example of FIG. 3, in operation, the SDID authentication engine 308 transmits an SDID via the WLAN radio 306. A wireless station query that includes the SDID, such as an authentication request, is received at the WLAN radio 306. The SDID authentication engine 308 recognizes the SDID as an ID, and authenticates the wireless station. In a security-enabled network, the SDID authentication engine 308 can also generate keys and encrypt communications. The SDID authentication engine 308 can also include a data store that has user accounts, associated access, and associated definitions. User accounts can include, for example, user names and passwords, as well as other metadata such as a last time the account was used. The stored user accounts can include guest accounts associated with the SDID and/or restricted services provided by the restricted services server 302.

Restricted services can include services publicly available within a wireless network to a guest station. For example, restricted services can include emergency telephone call access. Restricted services can also include providing location-specific audio recordings as part of an audio tour. Restricted services can also include digital advertisements within a supermarket. In general, practically any service can be provided as a restricted service over a wireless network.

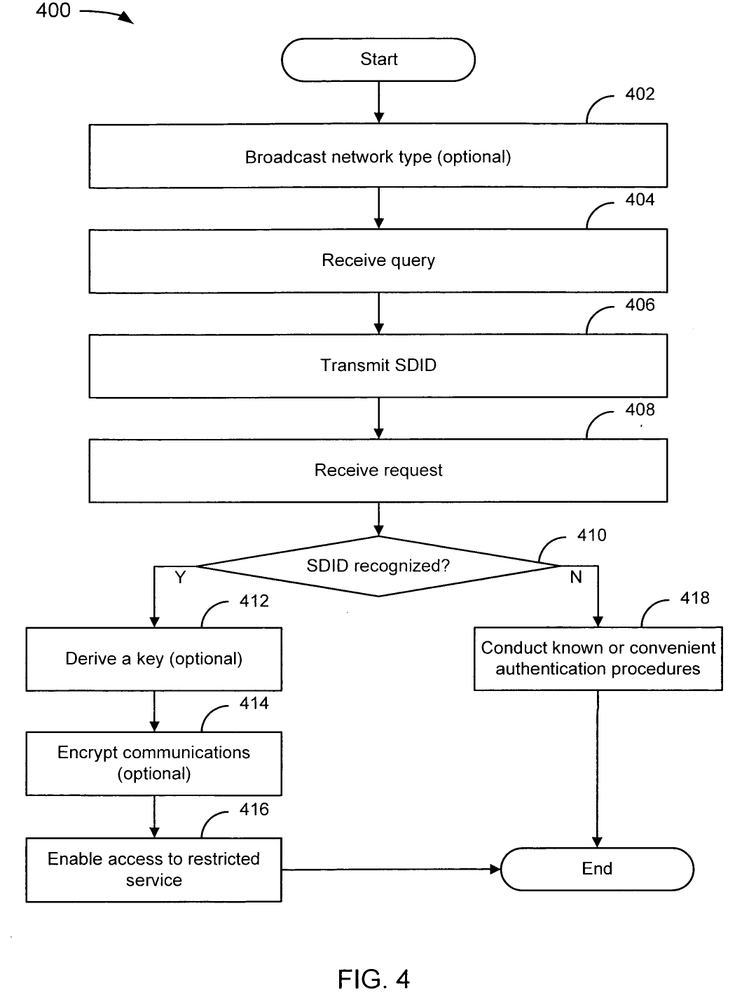

FIG. 4 depicts a flowchart 400 of an example of a method for providing restricted services on a wireless network. This method could be implemented at, by way of example but not limitation, an authenticator.

In the example of FIG. 4, the flowchart 400 starts at optional module 402 where a network type is broadcast. This module is optional because the network type need not be known to make use of this method. The network type may be broadcast in, by way of example but not limitation, in a beacon frame or advertisement.

In the example of FIG. 4, the flowchart 400 continues to module 404 where a query is received. The query can be received in a known or convenient manner.

In the example of FIG. 4, the flowchart 400 continues to module 406 where an SDID is transmitted. The SDID can include any information necessary for a client to successfully authenticate and gain access to a restricted service. The SDID may be transmitted via any known or convenient manner that will enable a wireless station to receive the SDID. The SDID can be transmitted to a wireless station associated with the query.

In the example of FIG. 4, the flowchart 400 continues to module 408 where a request is received. It may be noted that a wireless station may or may not send a request after sending a query to which a query to which an authenticator (e.g., an AP) has responded. However, for illustrative purposes, this is presumed.

In the example of FIG. 4, the flowchart 400 continues to decision point 410 where it is determined whether the SDID is recognized in the request. If it is determined that the SDID is recognized in the request (410-Y) then the flowchart 400 continues to a series of largely implementation-specific modules. For example, a key can be derived at optional module 412 and communications can be encrypted using the key at module 414. The encryption key can be derived from, by way of example but not limitation, a pre-shared secret, a Diffie-Hellman key exchange, an EIGamal encryption system, a symmetric or asymmetric key encryption algorithm, or any other secure mechanism. Eventually, after it is determined the SDID is recognized in the request, the flowchart 400 ends at module 416 where access to a restricted service is enabled.

If, on the other hand, the SDID is not recognized in the request (410-N), then the flowchart 400 ends at module 418 where known or convenient authentication procedures are conducted. For example, a wireless station that receives the transmitted SDID does not have to use the SDID, and could instead authenticate using a different identifier.

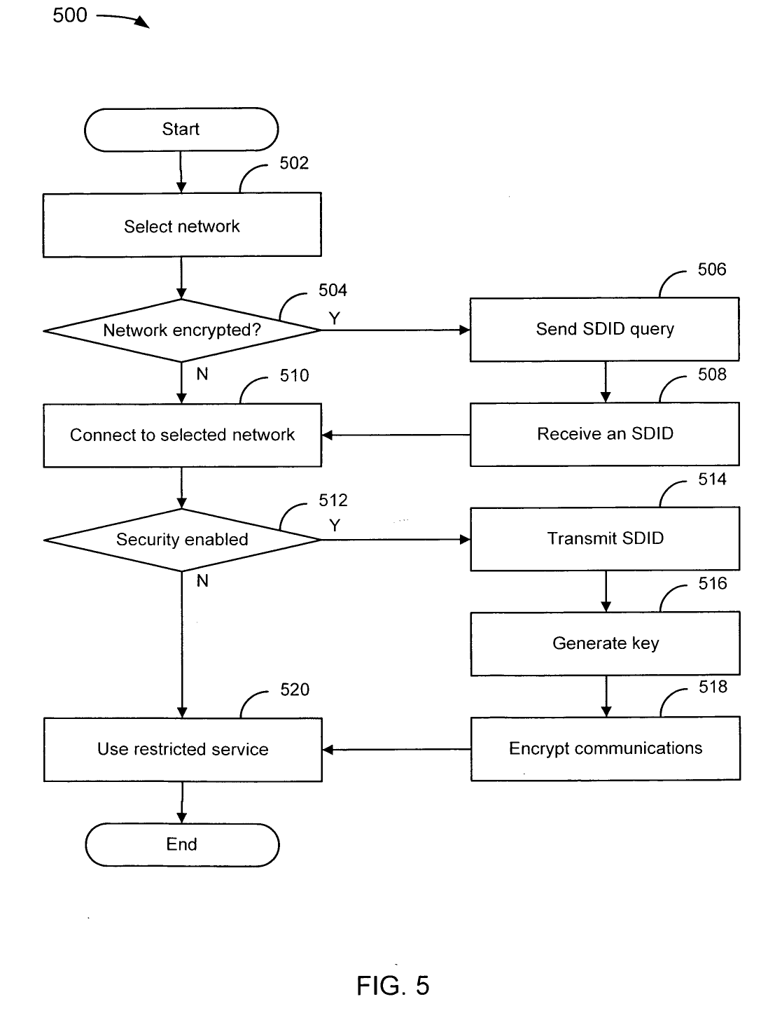

FIG. 5 depicts a flowchart 500 of an example of a method for accessing restricted services on a wireless network. This method would typically be employed by a wireless device.

In the example of FIG. 5, the flowchart 500 starts at module 502 with selecting a network. The selection of a network can be accomplished with or without user input. Where the selection is with user input, the selection may be explicit (e.g., the user picks the network from a list), the selection may be implicit (e.g., the user defines network preferences), or both (e.g., the user defines network preferences, is given a list of networks that match those preferences, and the user picks the network from the list).

In the example of FIG. 5, the flowchart 500 continues to decision point 504 where it is determined whether the network is encrypted. If it is determined that the network is encrypted (504-Y), then the flowchart 500 continues to module 506 with sending an SDID query, and to module 508 with receiving an SDID. It is assumed for illustrative purposes that the method is being carried out within range of a wireless network that can recognize an SDID query and therefore transmit an SDID in response to receiving the query.

In the example of FIG. 5, in any case, the flowchart 500 continues to module 510 where a connection to the selected network is made and to decision point 512 where it is determined whether the network is security enabled. If it is determined that the network is security enabled (512-Y), then the flowchart 500 continues to module 514 where the SDID is transmitted, to module 516 where a key is generated, to module 518 where communications are encrypted, and the flowchart 500 ends at module 520 where restricted services are used. If, on the other hand, it is determined that the network is not security enabled (512-N), then the flowchart 500 simply ends at module 520 where restricted services are used.

To this point, restricted services have been described as an either/or proposition. That is, either a wireless station has access to the restricted services or the wireless station has access to other, perhaps unrestricted (or less restricted), services. However, restrictions can be based upon Quality of Service (QoS) parameters, and the SDID can include QoS-related factors.

Dynamic QoS parameters may be configured through the use of a Remote Access Dial In User Service (RADIUS) attribute. However, QoS parameters might be further enhanced to, for instance, allow or disallow use of a particular 802.11e access class. For example, a device may be permitted to send video, but not be permitted to send voice.

Each access class can optionally have a utilization rate associated with it. When a device associates with a particular access class using Traffic SPECification (TSPEC), the request can be denied if it asks for more than a utilization rate. For example, a network administrator may impose a limit of 100 kbps of traffic to the voice queue per device; if a station requests more than the limit, the network will respond with a denial and the maximum allowable rate. Network administrators could use this type of feature to require clients to use lower-bandwidth codecs for Voice over Internet Protocol (VoIP).

QoS parameters can also be stored in a Lightweight Directory Access Protocol (LDAP) directory associated with the security credentials for a telephone. In such an implementation, the network could, for example, perform an LDAP query against the telephone's account and make that part of the session record.

The QoS configuration stored in the database could restrict access to particular access classes. It might say that a particular device is only allowed to do voice (if it is a telephone), or that it is only allowed best effort data (for a general-purpose device such as a laptop).

The QoS parameters, including any limits set by the dynamic configuration, can be passed around the network in a station switching record.

Users naturally want the best service possible and will be tempted to try and move their best effort traffic into the voice and video queues. Using specifications like the Trusted Computing Group's Trusted Network Connect (TNC), a system can be “validated” before it is allowed to use the network. That validation may include verifying that an appropriate program is running before allowing access to high-priority queues. For example, a validator may allow access to the voice queue only if a softphone is running on the client computer.

A capacity management and prioritization system may include a network system that takes into account the capacity of a particular access device as part of authentication. For example, a station that has requested QoS resources to which it is administratively allowed but are not available at the target access point might be redirected to a device at which those resources are available. Stations that are allowed on the network for best-effort service may initially be allowed on the network, but moved to a different access point when additional QoS is requested by, for example, a softphone.

In an embodiment, backend databases can be used to manage access to the high-priority queues. By way of example but not limitation, a backend database may include information about the relative importance of each user in access to a voice queue. By labeling priorities, the system may ensure that, for example, the CEO's telephone is always able to gain access to the voice queue at the expense of lower-ranking users.

With specific reference to the 802.11 standard, when dot11InterworkingServiceEnabled is set to true, TSPEC processing by the HC may be subject to limitations received from the SSPN interface. The SSPN may limit access to certain QoS priorities, and further restrict the data rate, delay, and throughput used with any priority. For example, the decision to admit the TSPEC or refuse it is based on both the available capacity as well as authorization information from the SSPN interface. The HC shall refuse to admit a TSPEC requesting service at a higher priority than authorized, with a lower delay bound, or that requests a data rate higher than that allowed by the SSPN. If capacity is available, the HC shall reply with a suggested TSPEC that is acceptable to the SSPN interface.

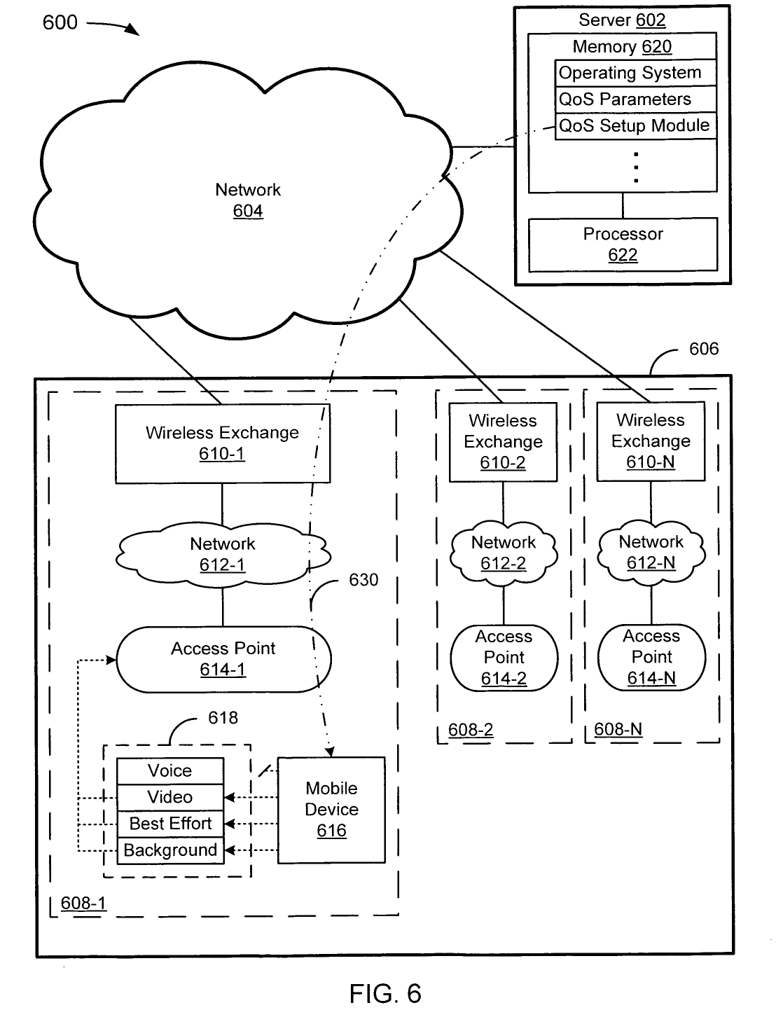

FIG. 6 depicts a system 600 including a wireless access domain. The system 600 includes a server 602, a network 604, and a wireless access domain 606. The system 600 may or may not include multiple wireless access domains. The server 602 may be practically any type of device that is capable of communicating with a communications network, such as, by way of example but not limitation, a mainframe or a workstation. The network 604 may be practically any type of communications network, such as, by way of example but not limitation, the Internet or an infrastructure network. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (the web). The physical connections of the Internet and the protocols and communication procedures of the Internet are well known to those of skill in the art.

In a non-limiting embodiment, the server 602 may be running a program such as, by way of example but not limitation, ethereal, to decode, by way of example but not limitation, IEEE 802.11 standard packets encapsulated in Tazmen Sniffer Protocol (TZSP) that are received from the wireless access domain 606. In a non-limiting embodiment, the server 602 is connected to a wireless backbone network (not shown), either directly or indirectly through a wireless network. The server 602 may include, by way of example but not limitation, a RADIUS server, an LDAP server, a policy server, a combination of these servers, or some other server.

In non-limiting embodiments, the wireless access domain 606 may be referred to as, by way of example but not limitation, a Local Area Network (LAN), virtual LAN (VLAN), and/or wireless LAN (WLAN). In an embodiment, the wireless access domain 606 may include one or more radios.

In the example of FIG. 6, the wireless access domain 606 includes access areas 608-1 to 608-N (hereinafter collectively referred to as access areas 608). The access areas 608 have characteristics that depend upon, among other things, a radio profile. A radio profile is a group of parameters such as, by way of example but not limitation, beacon interval, fragmentation threshold, and security policies. In an embodiment, the parameters may be configurable in common across a set of radios in one or more access areas 608. In another embodiment, a few parameters, such as the radio name and channel number, must be set separately for each radio. An example of the implementation of a wireless access domain, provided by way of example but not limitation, includes a Trapeze Networks “identity-aware” Mobility Domain™.

In the example of FIG. 6, the following elements are associated with each of the access areas 608: Wireless exchange switches 610-1 to 610-N (hereinafter collectively referred to as wireless exchange switches 610), networks 612-1 to 612-N (hereinafter collectively referred to as networks 612), and access points 614-1 to 614-N (hereinafter collectively referred to as access points 614).

In an embodiment, the wireless exchange switches 610 swap topology data and client information that details each user's identity, location, authentication state, VLAN membership, permissions, roaming history, bandwidth consumption, and/or other attributes assigned by, by way of example but not limitation, an Authentication, Authorization, and Accounting (AAA) backend (not shown). In an embodiment, the wireless exchange switches 610 provide forwarding, queuing, tunneling, and/or some security services for the information the wireless exchange switches 610 receive from their associated access points 614. In another embodiment, the wireless exchange switches 610 coordinate, provide power to, and/or manage the configuration of the associated access points 614. An implementation of a wireless exchange switch, provided by way of example but not limitation, includes a Trapeze Networks Mobility Exchange™ switch. The Trapeze Networks Mobility Exchange™ switches may, in another implementation, be coordinated by means of the Trapeze Access Point Access (TAPA) protocol.

In an embodiment, the networks 612 are simply wired connections from the wireless exchange switches 610 to the access points 614. The networks 612 may or may not be part of a larger network. In a non-limiting embodiment, the networks 612 provide a Layer 2 path for Layer 3 traffic, preserving IP addresses, sessions, and other wired Layer 3 attributes as users roam throughout the wireless access domain 606. By tunneling Layer 3 traffic at Layer 2, users stay connected with the same IP address and keep the same security and Quality of Service (QoS) policies from the wired network while they roam the wireless side.

In a non-limiting embodiment, the access points 614 are hardware units that act as a communication hub by linking wireless mobile stations such as PCs to a wired backbone network. In an embodiment, the access points 614 connect users to other users within the network and, in another embodiment, can serve as the point of interconnection between a WLAN and a fixed wire network. The number of users and size of a network help to determine how many access points are desirable for a given implementation. An implementation of an access point, provided by way of example but not limitation, includes a Trapeze Networks Mobility System™ Mobility Point™ (MP™) access point.

The access points 614 are stations that transmit and receive data (and may therefore be referred to as transceivers) using one or more radio transmitters. For example, an access point may have two associated radios, one which is configured for IEEE 802.11a standard transmissions, and the other which is configured for IEEE 802.11b standard transmissions. In a non-limiting embodiment, an access point transmits and receives information as radio frequency (RF) signals to and from a wireless client over a 10/100BASE-T Ethernet connection. The access points 614 transmit and receive information to and from their associated wireless exchange switches 610. Connection to a second wireless exchange switch provides redundancy.

A station, as used herein, may be referred to as a device with a media access control (MAC) address and a physical layer (PHY) interface to the wireless medium that comply with the IEEE 802.11 standard. As such, in a non-limiting embodiment, the access points 614 are stations. Similarly, a wireless client, such as the mobile device 616 of FIG. 6, may be implemented as a station. In alternative embodiments, a station may comply with a different standard than IEEE 802.11, and may have different interfaces to a wireless or other medium.

In the example of FIG. 6, the server 602 includes memory 620 and a processor 622. In the example of FIG. 6, the memory 620 includes an operating system, a QoS parameters database, and a QoS setup module. In operation, a policy configuration for the mobile device 616 includes setting or accepting QoS parameters for the mobile device 616 (or a user of the mobile device 616). The QoS setup module may provide the mobile device 616 with the policy configuration during association. In the example of FIG. 6, this QoS provisioning is illustrated by the arrow 630 from the QoS setup module to the mobile device 616.

In the example of FIG. 6, queues 618 are depicted for illustrative purposes (depending upon the implementation, the queues 618 may be considered a part of the access point 614-1). As is shown in the example of FIG. 6, the QoS provisioning 630 provides the mobile device 616 with access to background, best effort, and video queues, but no access to the high-priority voice queue. It should be noted that the policy could be configured to grant access to the high-priority voice queue if the mobile device 616 were running a VoIP application. However, for illustrative purposes, it is assumed that when the mobile device 616 was not running a VoIP application when it associated. Therefore, in the example of FIG. 6, access to the voice queue on the access point 614-1 is blocked.

If the user were allowed access to the voice queue (not shown) there could be an associated limit to voice traffic as well. For instance, a limit of 100 kbps on voice traffic to could be employed to limit users to one active telephone call.

Although the above embodiments have been discussed with reference to specific example embodiments, it will be evident that the various modification, combinations and changes can be made to these embodiments. Accordingly, the specification and drawings are to be regarded in an illustrative sense rather than in a restrictive sense. The foregoing specification provides a description with reference to specific exemplary embodiments. It will be evident that various modifications can be made thereto without departing from the broader spirit and scope as set forth in the following claims. The specification and drawings are, accordingly, to be regarded in an illustrative sense rather than a restrictive sense.

What is claimed is:

1. A method, comprising:
receiving a request from a wireless device for a restricted service provided over a wireless network;
if the wireless network is security enabled, transmitting a Service Descriptive Identifier (SDID) over the wireless network, wherein the SDID is associated with the restricted service;
recognizing the SDID in the received request;
responsive to recognizing the SDID, enabling a the wireless device to access the restricted service.

2. The method of claim 1, wherein the transmitting the SDID further comprises transmitting the SDID in a beacon frame.

3. The method of claim 1, further comprising:
generating a key;
encrypting communications with the wireless device using the generated key.

4. The method of claim 1, further comprising using an encryption key to encrypt communications between the wireless device, wherein the encryption key is derived from one of the group consisting of a pre-shared secret and a Diffie-Hellman key exchange.

5. The method of claim 1, wherein the wireless device includes a phone.

6. The method of claim 1, wherein the SDID is transmitted responsive to receiving a query from the wireless device.

7. The method of claim 1, wherein the wireless network is an 802.11 network.

8. A method, comprising:
receiving a Service Descriptive Identifier (SDID), wherein the SDID is associated with a restricted service provided over a wireless network;
responsive to an instruction to utilize the restricted service, using the SDID to request access to the restricted service;
accessing the restricted service on the wireless network.

9. The method of claim 8, wherein the SDID is received at a mobile device.

10. The method of claim 8, wherein the receiving the SDID further comprises obtaining the SDID from a beacon frame.

11. The method of claim 8, further comprising receiving the instruction by way of user input.

12. The method of claim 8, further comprising receiving the instruction by way of a decision-making engine.

13. The method of claim 8, further comprising:
generating a key;
encrypting communications with the wireless network using the generated key.

14. The method of claim 8, further comprising using an encryption key to encrypt communications with the wireless network, wherein the encryption key is derived from one of the group consisting of a pre-shared secret and a Diffie-Hellman key exchange.

15. The method of claim 8, further comprising transmitting a query to the wireless network, wherein the SDID is received responsive to the transmitted query.

16. The method of claim 8, further comprising associating the SDID with quality of service (QoS) parameters.

17. An authenticator, comprising:
a Wireless Local Area Network (WLAN) radio;
a Service Descriptive Identifier (SDID) authentication engine implemented in a computer-readable medium;
wherein, in operation:
the WLAN radio transmits an SDID, wherein the SDID is associated with a restricted service provided over a wireless network;
the WLAN radio receives a request from a wireless device for the restricted service;
the SDID authentication engine recognizes the SDID in the received request;
the SDID authentication engine, responsive to recognizing the SDID, enables access by the wireless device to the restricted service.

18. The system of claim 17, wherein the wireless device is a cellular phone.

19. The system of claim 17, wherein the restricted service includes an emergency call service.

20. The system of claim 17, wherein the authenticator is an 802.11-compatible access point (AP).
